(19) United States
(12) Patent Application Publication
(10) Pub. No.: US 2008/0234108 A1
(43) Pub. Date: Sep. 25, 2008

(54) OBSTACLE SUPPORTER HAVING A VARIABLE SIZE

(76) Inventor: Kathy M. Males, Wadsworth, IL (US)

Correspondence Address: BELL, BOYD & LLOYD, LLP, P.O. Box 1135, CHICAGO, IL, 60690, US

(21) Appl. No.: 11/689,912

(22) Filed: Mar. 22, 2007

(51) Int. Cl. A63K 3/04; A01K 15/02

(52) U.S. Cl. 482/16; 119/705

(57) ABSTRACT

An obstacle supporter for an obstacle assembly. The obstacle supporter includes: (a) a body which is at least partially flexible; and (b) a body support coupled to the body and which is adjustable between a plurality of different sizes. The obstacle supporter is convertible between a larger size for a use-mode and a relatively compact size for a non-use mode. Two or more obstacle supporters can be spaced apart to support an obstacle therebetween.

### BACKGROUND

In track and field athletics, hurdles are used as obstacles around the perimeter of a racetrack, in high jumping, and in pole vaulting. In animal or pet shows, such as dog shows, hurdles and other barriers are used to demonstrate agility, obedience and other behavioral traits. These known hurdles and barriers are relatively bulky and heavy and are made mostly out of rigid materials such as wood, metal and hard plastic. These types of hurdles and barriers can be difficult or inconvenient to assemble, transport and store.

Accordingly, there is a need to overcome the disadvantages described above or otherwise lessen the effects of such disadvantages.

### SUMMARY

In one embodiment, the present disclosure includes an obstacle supporter for an obstacle assembly. The obstacle supporter includes a body and one or more body supports. Depending upon the embodiment, the body can be partially flexible or fully flexible. The body support is coupled to the body and the body is adjustable between a plurality of different sizes or dimensions. The body and the body support cooperate to enable the obstacle supporter to convert between a larger size for a use-state and a relatively compact size for a storage or non-use state. Two or more obstacle supporters can be spaced apart to support an obstacle to be traversed by a participant or user, including, but not limited to, a human, domesticated animal, pet, dog, cat, horse, any other animal or a robot.

Additional features and advantages are described herein, and will be apparent from, the following Detailed Description and the figures.

### BRIEF DESCRIPTION OF THE FIGURES

FIG. 1 is a front schematic view of the obstacle assembly in one embodiment.

FIGS. 2A and 2B are perspective views of the obstacle supporter in a compressed state and an expanded state in one embodiment.

FIGS. 3A and 3B are perspective partial breakaway views of an obstacle assembly having a pair of tubular shaped support members, according to an embodiment.

FIGS. 4A to 4C are perspective views of obstacle assemblies illustrating alternative obstacle arrangements, according to embodiments.

FIGS. 5A and 5B are perspective partial breakaway views of obstacle assembly having a pair of rectangular shaped obstacle supporters, according to an embodiment.

FIG. 5C is a perspective view of the embodiment of the obstacle assembly illustrated in FIGS. 5A and 5B, where one of the rectangular shaped support members is in a partially compressed state.

FIG. 5D is a perspective view of the embodiment of the obstacle assembly illustrated in FIGS. 5A and 5B, where one of the rectangular shaped support members is in a fully compressed state.

FIG. 6 is a perspective partial breakaway view of an obstacle, according to an embodiment.

FIGS. 7A and 7B are perspective views of an obstacle assembly having a pair of triangular shaped obstacle supporters, according to embodiments.

FIGS. 8A to 8F are perspective views of obstacle assemblies illustrating alternative obstacle support and obstacle arrangements, according to embodiments.

### DETAILED DESCRIPTION

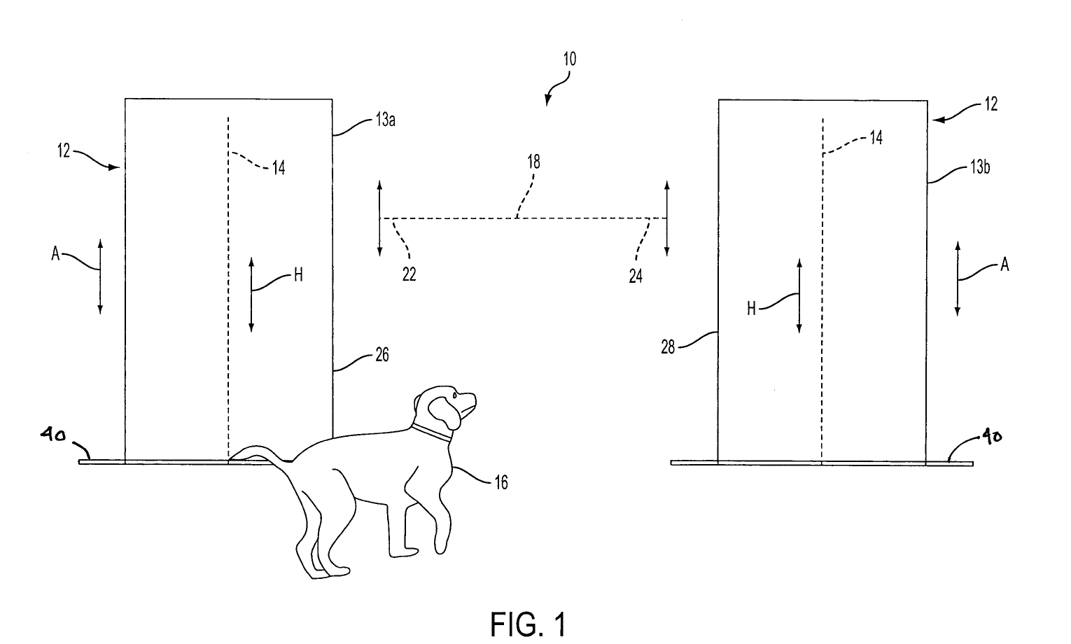

Referring now to the drawings, FIGS. 1A to 8F illustrate different embodiments of an obstacle assembly which is operable as an obstacle or barrier, or as training or performance testing device for participants and users.

### I. General Embodiment

As illustrated in FIG. 1, in one embodiment, the obstacle assembly 10 includes a plurality of obstacle supporters 12, each of which has: (a) a body 13; and (b) a body support 14 that is couplable to the body 13 and configured to support the body 13 in a plurality of different positions. In one embodiment, two or more of the obstacle supporters 12 may be connected together to support an obstacle 18, as indicated schematically by the dashed line. The obstacle 18 is positioned between the obstacle supporters 12 at a suitable height such that a participant or user 16 can jump, leap, pass under, pass through, or otherwise traverse the obstacle 18. In one embodiment, each body support 14 has a height (H) which is variable, as indicated by the double-headed arrows, between: (a) a storage position where such body 13 is collapsed; and (b) an in-use position where such body 13 stands upright. Because the body support 14 is connected to the body 13, the entire obstacle supporter 12 has a height (A) which is also variable. Depending on the embodiment, each body support 14 can have a spring-like structure, an elastic characteristic, a telescoping structure, a linked structure, or any other suitable supporting structure enabling size or shape adjustment. In the linked structure, the body support 14 has a chain of separate tubes, a chord, wire, cable or line passing through all or some of the tubes, and a coupler between each tube.

### A. Body

With continued reference to FIG. 1, the body 13 may be made of any suitable material that can change configuration or formation between a collapsed, compressed or compacted state and an expanded or extended state. In one embodiment, the body 13 is a flexible or non-rigid or semi-non-rigid fabric material that is at least partially unable to support itself in the expanded position. The body 13 can be made from natural fabric materials such as silk, cotton, wool, or from synthetic materials such as polyesters, aramids, acrylics, Nylons, spandex or elastane, and olefin fibers, or any suitable combination thereof. Although certain examples have been described, it should be appreciated that the body material may include any natural or artificial cloth fiber or textiles, plastics, rubber, polymeric materials, or any other suitable materials that have at least a semi-non-rigid, flexible or conformal characteristic. In one example, the body 13 is fully flexible.

In an embodiment, when the body 13 is in the compressed or compacted state, the overall dimensions are reduced to a packed or storage profile such that the obstacle supporters 12 may be more easily stored or transported during non-use. When the body 13 is in the expanded state, the obstacle supporters 12 function as part of the entire obstacle assembly 10. Specifically, when the body 13 is in an expanded or erect state, and supported by one or more body supports 14, it is operable to be coupled or attached to an obstacle 18 such as a bar, curtain, hoop or strap. In one embodiment, the body 13 includes one or more anchors or straps 40 that are used in combination with a stake, a weight, or some other object (not shown) to provide additional vertical stability to the obstacle supporters 12. It should be appreciated that the anchors 40 may be used in any of the embodiments described below.

In one embodiment, two obstacle supporters 12 may be spaced apart a distance, as shown in FIG. 1. When both of the bodies 13 of the obstacle supporters 12 are converted to the expanded or extended state by the body supports 14, the obstacle supporters 12 attain a height sufficient to accommodate an obstacle 18. The obstacle 18 is releasably attached or coupled to the obstacle supporters 12 at a height sufficient to allow for jumping or leaping over, through or under the obstacle 18. The obstacle 18 presents a target for a user or participant 16 to jump over, around, under or through.

### B. Body Supporter

In general, the body support 14 is a rigid, semi-rigid, or at least partially flexible member or members that provides support to or otherwise aids the obstacle supporter 12 in maintaining an expanded position when in use. The body support 14 may be propped up beneath the obstacle supporter 12, attached to the obstacle supporter 12, inserted into an interior portion of the obstacle supporter 12, mounted within the obstacle supporter 12, or otherwise suitably coupled to the obstacle supporter 12 to provide a measure of support. In one embodiment, the body support 14 includes one or more rigid, or semi-rigid tubes or poles. The poles may be separate or elastically attached end to end to form a segmented longer pole. In another embodiment, the body support 14 includes one or more resilient hoops. In another embodiment, the body support 14 includes a partially flexible coil spring or helical spring. In another embodiment, the body support 14 includes one or more partially flexible wires, cables, or lines with a designated stiffness that are received by a portion of the body 13. However, it should be appreciated that the body support 14 may be any suitable convertible structure that provides for a certain amount of support for the obstacle supporter 12. The body support 14 may be made of fiberglass, a metal or metal alloy, plastic, wood, ceramic or any other suitable rigid, partially rigid, or partially flexible material.

In the above mentioned embodiments, the one or more body supports 14 are received by a portion of the body 13. The body supports 14 may be received in a vertical, horizontal, diagonal, helical, zig-zag, serpentine, or patterned configuration, or any suitable combination thereof.

### C. Obstacle

Referring to FIG. 1, the obstacle 18 includes one or more members that are connected to, and supported by, two or more of the obstacle supporters 12. The obstacle 18 provides a barrier or obstacle around, over, under, or through which a user or participant may pass. In general, one end 22 of the obstacle 18 is coupled to an end or side 26 of a first obstacle supporter 12a, and another end 24 is coupled to an end or side 28 of a second obstacle supporter 12b. It should be appreciated that the obstacle 18 can be removably attached, affixed to, coupled, linked, or mounted to the sides 26 and 28 of the obstacle supporters 12a and 12b. One or more obstacles 18 may be provided between two obstacle supporters 12a and 12b. When more than one obstacle 18 is used, the obstacles 18 may be spaced vertically or horizontally apart. When a plurality of obstacles are spaced apart side-by-side or horizontally, the form of obstacles 18 provide not only a height that the participant or user must clear, but also a distance across the obstacles 18.

In one embodiment, the obstacle 18 is a rope or strap supported by two obstacle supporters 12. In another embodiment, the obstacle 18 includes a hoop through which a user may jump. It should be appreciated that the obstacle 18 can also be in the form of a curtain, a sheet, a pole, a pole and strap combination, or any other suitable form of obstacle that connects to, and is supported by, two or more obstacle supporters 12.

### II. Cylindrical Embodiment

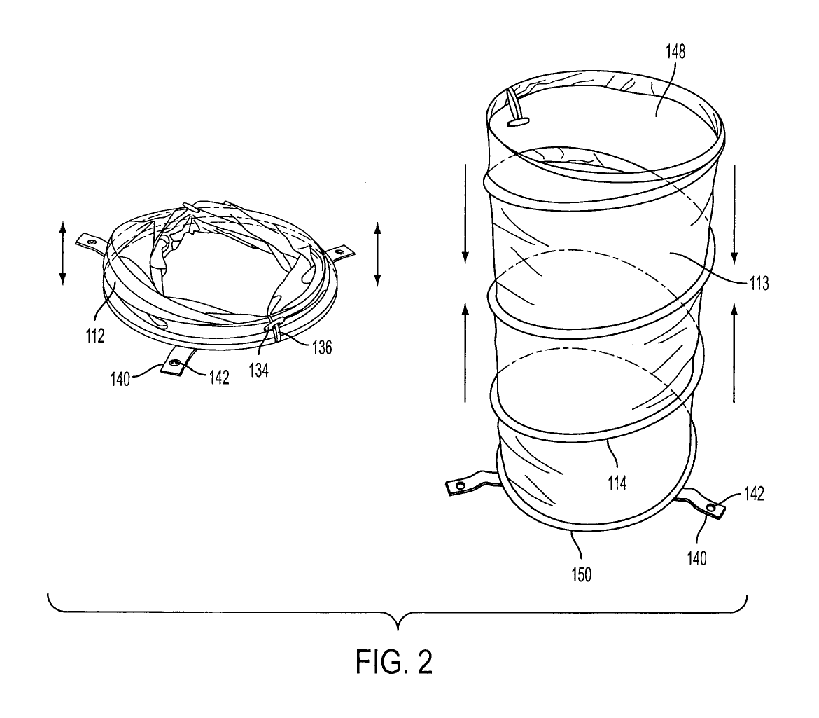

As illustrated in FIGS. 2, 3A, 3B, 4A, 4B and 4C, in one embodiment the obstacle assembly 100 includes a plurality of obstacles supporters 112, each of which has: (a) a barrel-shaped, tube-shaped or cylindrically-shaped body 113; (b) a coil-shaped body support 114 coupled to each body 113; and (c) one or more obstacles 118 removably attached to the obstacle supporters 112. In one or more embodiments described below, the obstacle assembly includes two obstacle supporters 112 which have bodies 113a and 113b. In the following description, only one of the obstacle supporters 112 is described because the obstacle supporters 112 are identical in one embodiment. It should be appreciated that in other embodiments, the obstacle supporters and bodies may be different. Also, it should be appreciated that an obstacle supporter and body combination according to one embodiment may be combined with an obstacle supporter and body combination according to a different embodiment.

### A. Cylindrical Bodies

As illustrated in FIG. 2, the body 113 is adjustable between a compressed, compacted, or non-use state and an expanded, extended, or use-state state. In an embodiment, the body 113 is a fully flexible material such as a fabric. The fabric is sewn or arranged to form a tube of fabric. The body 113 forms a hollow tube or passageway with open ends 148, 150. However, it should be appreciated that in other embodiments the one or more of the ends 148, 150 of the tube-shaped body 113 can be closed with end caps (not shown). In an embodiment, each body 113 is collapsible, that is, the body 113 is not self-supporting or fully self-supporting without the coil-shaped body support 114 (described in detail below).

It should be appreciated that the body 113 may include one or more graphical elements imprinted thereon or affixed thereto to have visual or informational effects (see, FIGS. 8A to 8E). For example, the visual elements may include information of use to a trainer or user, such as a station number, height, width, or obstacle type. Also, the visual elements may include information that is of use to the user negotiating the obstacle assembly 100. The visual elements may include psychological elements for a participant or user negotiating the obstacle assembly 110. For example, the visual elements may include a picture or structure of a fence such that a participant or user feels more comfortable jumping over the obstacle assembly 110. In another embodiment, the graphical elements are advertisements such as banner ads that can be observed by both the participant or user and other viewers or spectators. The advertisements may be imprinted directly onto the body 113 or may be attached thereto with an attachment device or fastening device. In one embodiment, the body 113 has a banner holder.

Referring to FIG. 2, the body 113 includes one or more ties, fasteners or securing members 134, 136 to retain the body 113 in the compressed state. As best shown in FIG. 2, the fastener or securing member includes a strap having a loop 134 and another strap having a hook 136. One end of the loop 134 is secured to the fabric of the body 113. The strap having the loop 134 is of a sufficient length that, when the body 113 is in the compressed state, can be wound around the compressed tube-shaped body 113. The hook 136 is inserted through the loop 134 to constrain the obstacle supporter 112 in the compressed or collapsed state. As described in further detail below, the coil-shaped body support 114 has a resilient characteristic, such as in a spring, that biases the body 113 to have a predisposed expanded or extended state. Therefore, the securing member 134 effectively opposes the biasing force of the body support 114. It should be appreciated that one or more securing members 134, 136 may be circumferentially spaced about the perimeter of the body 113. When the hooks 136 are removed from the loops 134, the body 113 is able to expand or extend. Although the securing members have been described as a hook 136 and loop 134 combination, it should be appreciated that any suitable securing member or members can be used that are sufficient to at least temporarily retain the body 113 in the compressed state. For example, the securing member can include snaps, elastic bands or hook and loop fasteners.

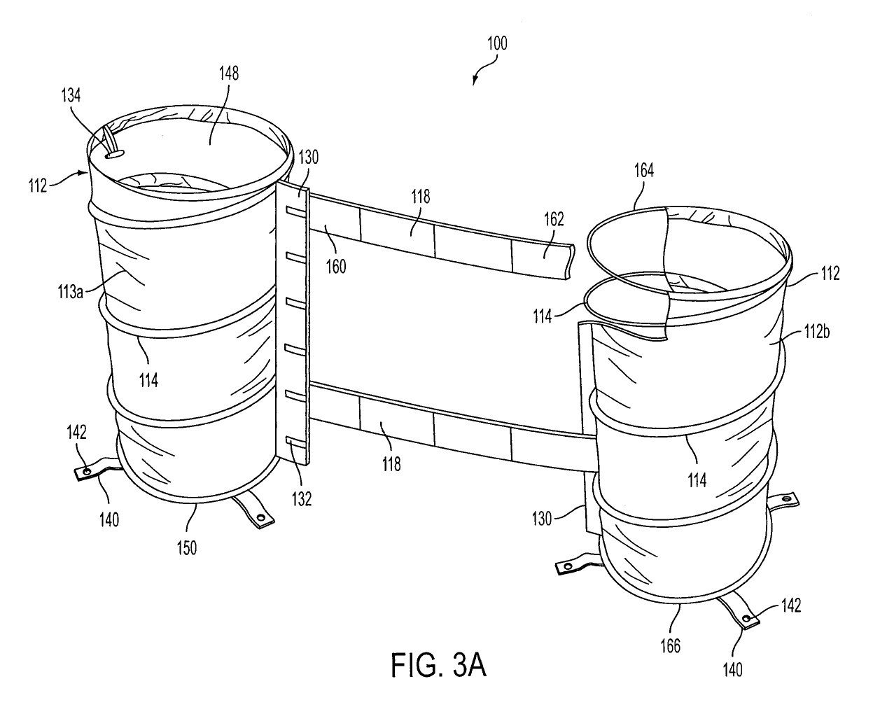

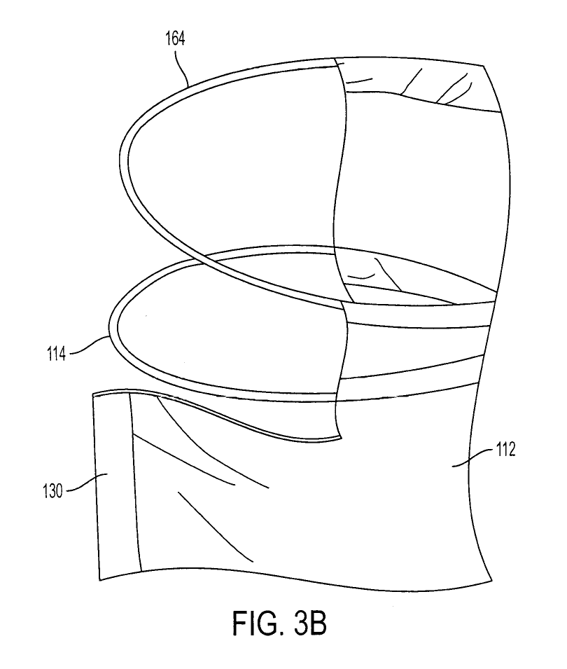

Referring to FIG. 2, in an embodiment, the body 113 includes one or more tie down straps or anchor straps 140. Each anchor strap 140 has one or more eyelets 142 or openings. A stake (not shown) or other securing member can be inserted through the eyelets 142 in the anchor strap 140 and into the ground in order to further secure the body 113 in an upright position. The anchor straps 140 can be spaced circumferentially around the base portion 166 (see, FIG. 3A) such that when the body 113 is in the extended position and the stakes are inserted through the eyelets 142 into the ground, the body 113 resists tipping or falling. In one embodiment, the anchor strap has a surface area sufficient to be held in place by a portable weight. For example, a user can enhance the stability of the obstacle supporter 112 on a concrete, wood, or an artificial turf surface by placing a weight on one or more of the straps 140. It should be appreciated that in other embodiments, the anchor straps 140 are omitted and the base portion 152 of the body 113 is of a sufficient diameter or profile to stably maintain the body 113 in an upright position when in the extended position.

The body 113 also includes one or more vertical securing members or fasteners 130, as shown in FIG. 3A. In one embodiment, the securing member 130 is a strip of fabric that is attached to the body 113 and is oriented in a vertical direction. The securing member 130 is a flexible elongated strap, belt, or piece of fabric that is sewn or otherwise secured to the body 113 in a removable or non-removable fashion. The securing member 130 runs substantially along the entire height of the body 113 and is adapted to receive one end 160 or 162 of the obstacle 118 (described in detail below) at a plurality of different heights.

In one embodiment, the securing member 130 includes a re-adjustable fastener such as of the hook-and-loop type (or burr and touch type) located along the length of the securing member 130. In general, a hook type fastener is a piece of fabric covered with tiny plastic hooks, and a loop type fastener is a piece of fabric that is covered with even smaller plastic loops. It should be appreciated that variations to this configuration may be used which include hooks on both pieces of fabric, for example. When the hooks (or loops) on the securing member 130 contact the loops (or hooks) on the end 160, 162 of the obstacle 118, the hooks catch in the loops and removably attach the pieces together. As the end 160, 162 of the obstacle 118 includes a corresponding loop-type or hook-type fastener, and the securing member 130 is a vertical strip including the corresponding hook or loop fasteners, the obstacle 118 can be removably attached to the securing member 130 at any of a plurality of different heights. Therefore, the obstacle assembly 100 is able to function as a leaping obstacle that can be adjusted to many different levels. Although the securing member 130 is described above as a strip having a hook-type or loop-type fastening member, it should be appreciated that the securing member may be any suitable configuration that allows one or more obstacles 118 to be removably attached to the body 113 at a plurality of different heights. For example, the securing member 130 may include a plurality of snaps that mate with a snap included on the end 160, 162 of the obstacle 118.

In one embodiment, the securing member 130 is a strap or strip sewn onto the body 113, where the strip includes a first side having a fastener and a second side having a plurality of symbols, indicators, or markings 132. The markings 132 may be numbers that indicate the height from the ground. For example, the securing member 130 can include numbers indicating the number of inches from the ground at a plurality of different heights. In this example, when the jump obstacle 118 is removably attached to the securing member 130 of the body 113, participant or user can determine the height of the obstacle 118. In another example, where the obstacle assembly 100 includes two bodies 112 spaced apart a distance, the markings 132 on one of the bodies 112 can be oriented in a first direction, and the markings 132 on a second one of the bodies 112 can be oriented in a second direction, as illustrated in FIG. 3A. As such, the second direction is rotated approximately 180° relative to the markings 132 on the first one of the bodies 112. In this manner, the markings 132 are viewable when approaching the obstacle assembly 100 from either direction. In this example, it follows that the hook-type or loop-type fastener on the securing member 130 of the first body 113a would likewise be oriented approximately 180° from the hook-type or loop-type fastener on the securing member of the second body 113b, as shown in FIG. 3A.

### B. Coil-Shaped Body Support

The support for the body 113 is a coil-shaped body support 114. In one embodiment, the coil-shaped body support 114 is a flexible line with a designated stiffness, such as a steel cable formed into a coil is used, and the body 113 holds the flexible line in a designated coil shape. The body support 114 may be made of any suitable elastic material such as plastic or metal. The coil-shaped body support 114 is affixed, adhered or otherwise coupled to the body 113. Where the body 113 is a fabric such as nylon, the coil-shaped body support 114 can be sewn into or onto the body 113. In one example, the body 113 is a single sheet of fabric and the coil-shaped body support 114 is sewn onto an inside surface of the body 113 with a strip of fabric that runs the length of the coil. In another example, the flexible line extends through a sleeve defired by the body 113. It should be appreciated that the body support 114 may be affixed or sewn to the inside or outside of the body 113 in any suitable fashion.

In an embodiment, the coil-shaped supporting member or support 114 is biased toward the expanded position. Therefore, the coil-shaped body support 114 enables the body 113 to expand and contract in an accordion-type fashion. When the body 113 is in the contracted or compact position, as shown in FIG. 2, the body support 114 stores potential energy. When the securing members 134, 136 are released, the coil-shaped body support 114 expands and releases the stored potential energy as the body 113 converts from the compact state to the expanded or extended state.

In one embodiment illustrated in FIGS. 3A and 3B, the coil-shaped body support 114 includes two ends 164 and 166 that each form a substantially circular and horizontal top and base of the body 113. The top and base portions provide additional support for the body 113 and aid the body 113 in maintaining an upright position when in the expanded state.

In an embodiment, the coil-shaped body support 114 is a single flexible line with a stiffness that is inserted through a sleeve. The coil-shaped body support 114 may be wound around the outer wall of the body 113 and may be made of plastic, metal, or any suitable material having a stiffness and a resiliency characteristic.

### C. Obstacles

The obstacle 118 of the obstacle assembly 100 is provided between two or more bodies 113a and 113b and is positioned at a height above a ground level such that a user or participant can pass around, over, under, or through the obstacle 118. As shown in FIG. 3A, one end 160 of the obstacle 118 is releasably attached to the securing member 130 of one of the bodies 113a. Another end 162 of the obstacle 118 is releasably attached to another one of the bodies 113b. As described above, the obstacle 118 can be attached to the bodies 113a and 113b at a plurality of different heights. Also, as shown in FIG. 3A, two or more obstacles 118 can be attached to the bodies 113a and 113b.

In one embodiment, the obstacle 118 is a flexible strap, as shown in FIG. 3A. The flexible strap includes an interior space that houses a filler such as a foam, a padding, or other suitable material. In one example, fabric is sewn around the padding to create a semi-rigid yet soft material. The soft material can help reduce the occurrence of injuries to a participant and can also add stiffness to reduce sagging of the obstacle 118. Each of the ends 160 and 162 of the obstacle 118 includes a fastener such as a portion of a hook-and-loop device, as described above. The fastener of the obstacle 118 is adapted to be releasably attached to the body 113 of the obstacle assembly 100. In an embodiment, the fasteners at the ends 160 and 162 of the obstacle 118 are located on opposing surfaces. This allows the ends 160 and 162 of the obstacle 118 to be attached to different sides of the securing members or fasteners 130 of two separate bodies 113a and 113b. As mentioned above, where the fasteners 130 of the bodies 113a and 113b include markings 132 to indicate different heights, the bodies 113a and 113b can be oriented approximately 180° to one another such that the heights can be viewed from two approach directions.

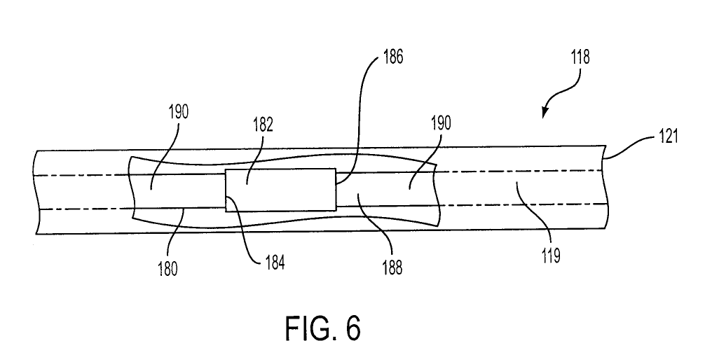

Referring to FIG. 6, in one embodiment, the obstacle 118 is a flexible strap 119. The flexible strap 119 includes an interior space or pocket 121 that is adapted to receive a stiffening member 180 such as a rod or pole. The stiffening member 180 can be a single member. Alternatively, as shown in FIG. 6, the stiffening member 180 can be a segmented member having a plurality of segments 190 connected together through joints 182. In one embodiment, a joint 182 is affixed to an end 184 of one of the segments 190. The other end 186 of the joint 182 includes a hollowed-out portion that is adapted to receive the end 188 of a different segment 190. In one example, an elastic line extends through all of the segments, and the line elastically connects the segments 190 to one another such that stiffening member 180 is a singly connected piece. The elastic line (not shown) may be an elastic cord or rubber band, or any other suitable elastic member that enables one segment 190 to be separated from another segment 190 while retaining an elastic connection therebetween.

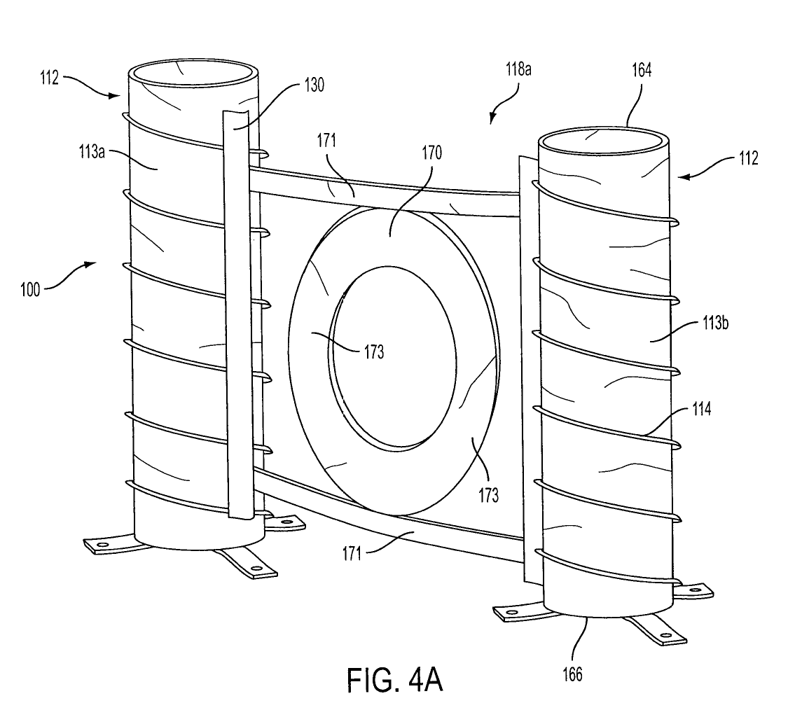

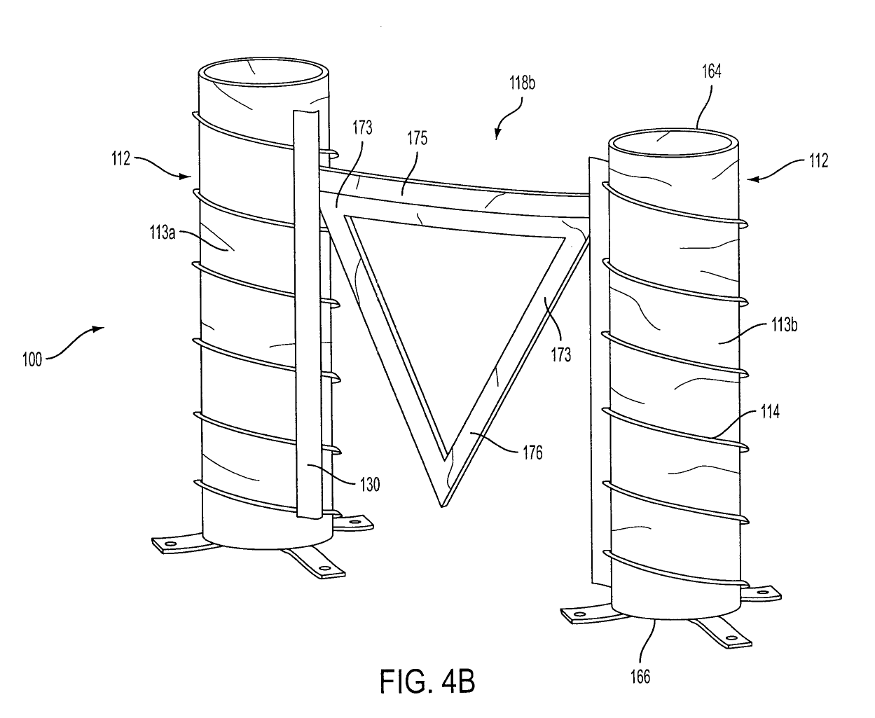

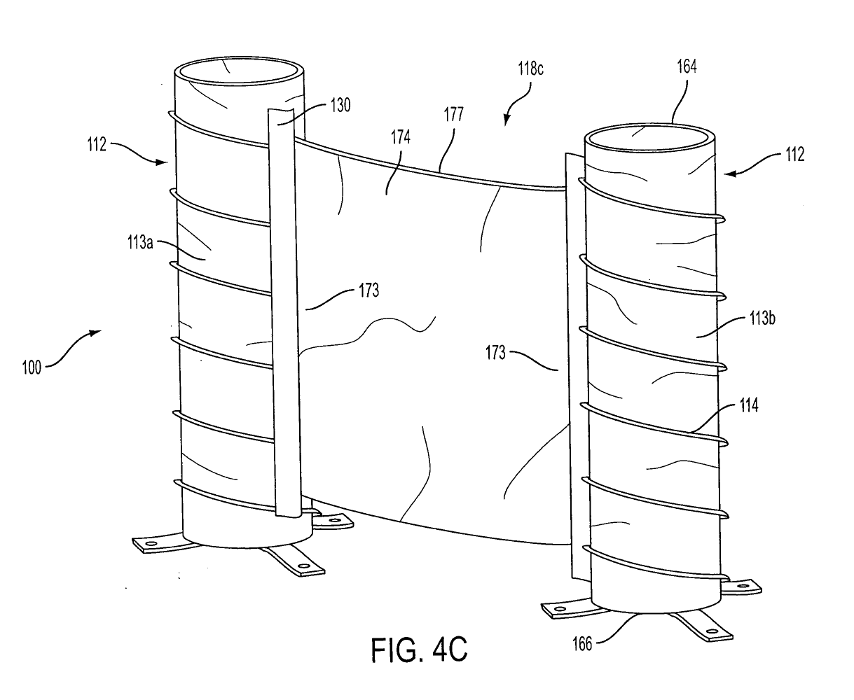

In one embodiment shown in FIG. 4A, the obstacle 118a includes a plurality of straps 171, and a circular hoop 170 suspended between or supported by straps 171. The straps 171 are releasably attached to a plurality of bodies 112, as described above. In another embodiment, the straps 171 are omitted and the sides 173 of the hoop 170 are directly attached to the bodies 113a and 113b. In either of such embodiments, the hoop 170 can be releasably attached to the bodies 113a and 113b at a plurality of different heights. The hoop 170 provides a participant or user with not only a height to clear, but also a confined space through which the participant or user must pass. Accordingly, the obstacle assembly 100 having a circular hoop-shaped obstacle 118 is effective as an agility training apparatus for a participant.

In another embodiment shown in FIG. 4B, the obstacle 118b includes a strap 175, and a triangular hoop 176 suspended or supported by the strap 175. The strap 175 is releasably attached to a plurality of bodies 113a and 113b, as described above. In another embodiment, the strap 175 is omitted and the sides 173 of the triangular hoop 176 are directly attached to the bodies 113a and 113b. In each of the embodiments having a triangular hoop-shaped obstacle 118, the hoop 176 can be releasably attached to the bodies 113a and 113b at a plurality of different heights. Similar to the circular hoop 170 described above, the triangular hoop 176 provides a participant or user with not only a height to clear, but also a confined space through which the participant or user must pass. Accordingly, the obstacle assembly 100 having a triangular hoop-shaped obstacle 118 is also effective as an agility training apparatus for a participant.

In one embodiment shown in FIG. 4C, the obstacle 118c is a wall or curtain 174, and the sides 173 of the curtain 174 are directly attached to the bodies 113a and 113b. In each of the embodiments having a curtain 170 as an obstacle, the curtain 170 can be releasably attached to the bodies 113a and 113b at a plurality of different heights. It should be appreciated that the curtain 174 may include one or more graphical elements, as discussed above (see also, FIGS. 8A to 8E). In addition, the top portion 177 of the curtain 174 may be altered in shape. For example, the top portion 177 can be jagged (not shown) to represent the top portion of a fence post. Also, in an embodiment, the wall or panel or curtain 174 includes one or more openings or windows through which a user or participant can pass. The openings may be circular, square, rectangular, triangular, or of any other suitable shape that enables a participant to pass through.

### III. Box-Shaped Embodiment

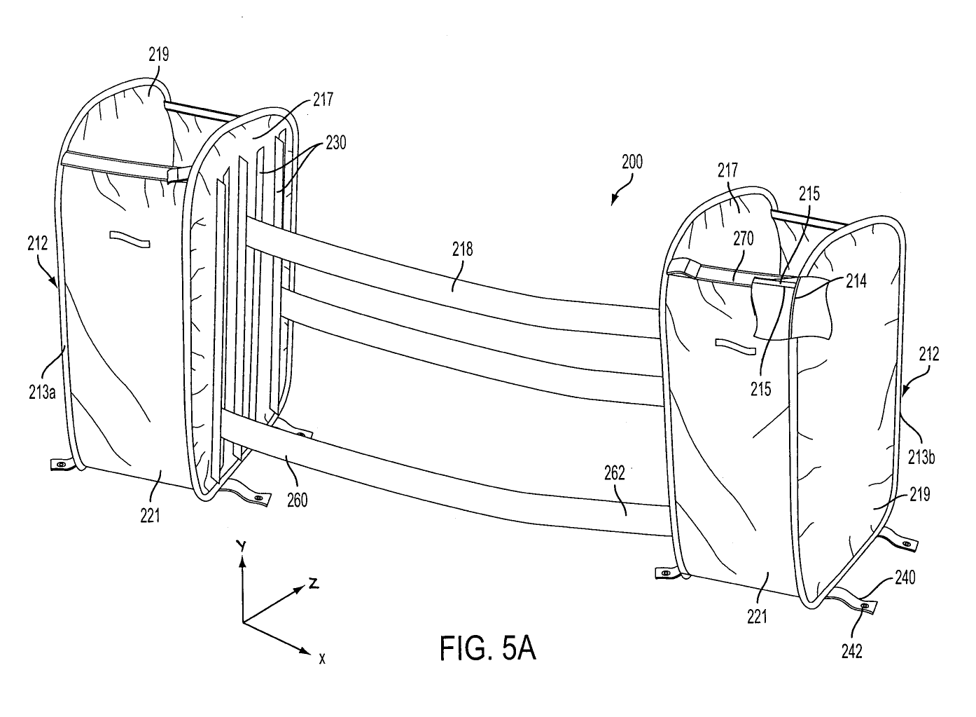

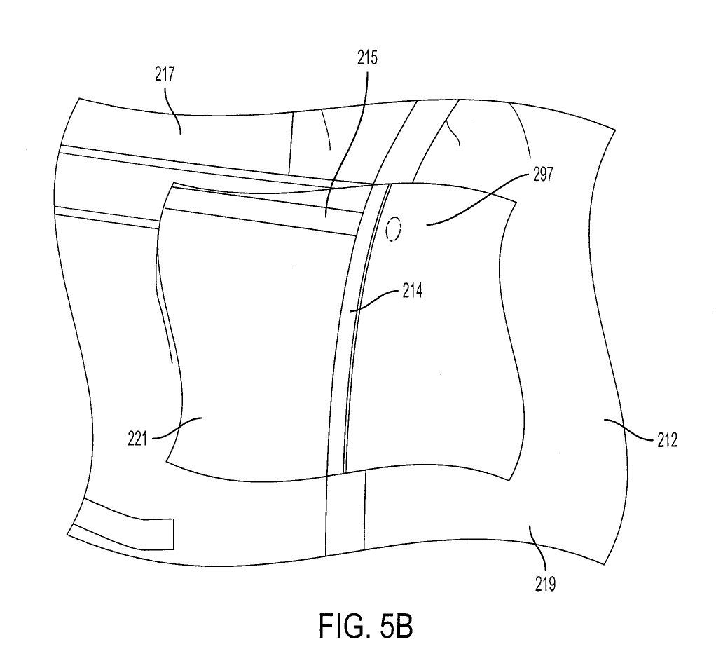

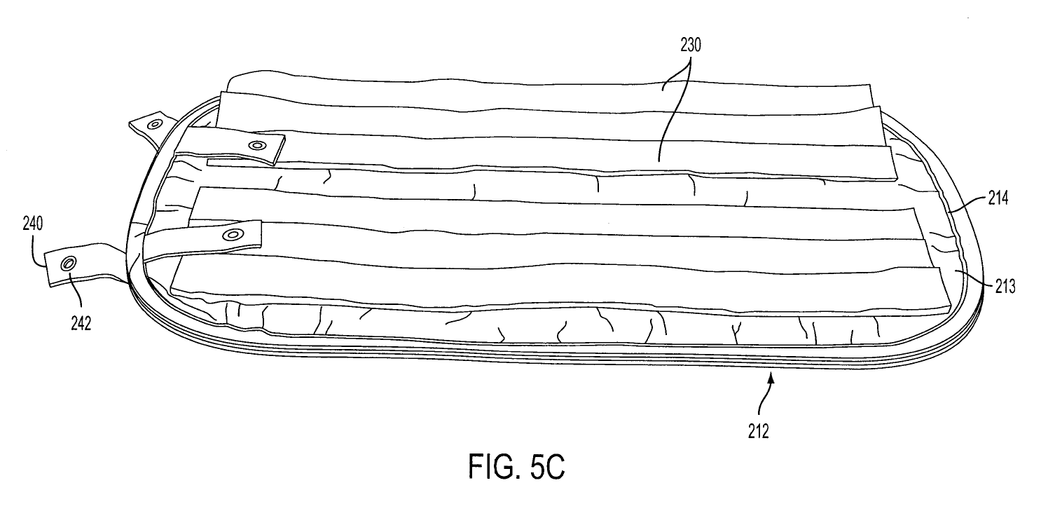

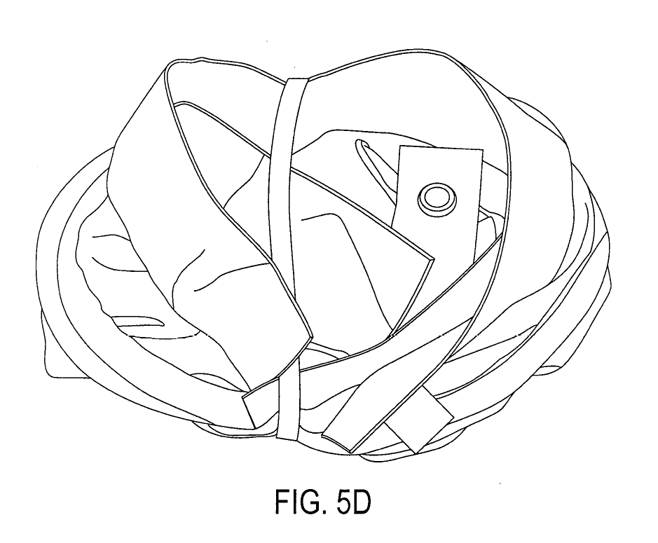

As illustrated in FIGS. 5A, 5B and 5C, in one embodiment the obstacle assembly 200 includes a plurality of obstacle supports 212 each having: (a) a plurality of square or rectangular-shaped bodies 213a and 213b; and (b) a plurality of outer supports 214 and 215 operatively coupled to each of the bodies 213a and 213b, each body supporter 214 generally corresponding to the rectangular shape of the bodies 213a and 213b; and (c) one or more obstacles 218 removably attached to the bodies 213a and 213b.

### A. Rectangular-Shaped Bodies

As shown in FIGS. 5A and 5C, the bodies 213a and 213b are adjustable between a fully expanded or extended state (as shown in FIG. 5A), a partially compressed, collapsed, or compacted state (as shown in FIG. 5C), and a fully compressed, or non-use state (as shown in FIG. 5D). The bodies 213a and 213b each include an inner wall 217, an outer wall 219, and a front wall 221. In an embodiment, the body 213 is a fully flexible material such as a fabric. The fabric is sewn or arranged to form a generally square or rectangular shape. In an embodiment, the body 213 is not fully collapstable, that is, the body 113 is not self-supporting or fully self-supporting without the body supports 214 and 215 (described in detail below). It should be appreciated that the body 213 may include one or more graphical elements imprinted thereon or affixed thereto to have visual or informational effects, as described above.

The body 213 includes one or more fasteners or securing members (not shown) to retain the body 213 in a compressed or collapsed state. The fastener or securing member may be a strap having a loop and a hook as described above, an elastic band, a rope, a container, a fabric envelope or pouch, or any other suitable securing member that at least temporarily maintains the body 213 in a collapsed state. As described in detail below, the rectangular-shaped outer supports 214 have a resiliency characteristic that biases the body 213 to at least a partially expanded or extended state. Therefore, the securing member effectively opposes the biasing force of the outer supports 214.

Referring to FIG. 5A, in an embodiment, the body 213 includes one or more tie down straps or anchor straps 240. Each anchor strap 240 has one or more eyelets 242 or openings. A stake (not shown) or other securing member can be inserted through the eyelets 242 in the anchor strap 240 and into the ground in order to further secure the body 213 in an upright position. The anchor straps 240 can be spaced around the base portion 252 such that when the body 213 is in the extended position and the stakes are inserted through the eyelets 142 into the ground, the body 213 resists tipping or falling. In one embodiment, the anchor strap has a surface area sufficient to be held in place by a portable weight. For example, a user can enhance the stability of the obstacle supporter 212 on a concrete, wood, or an artificial turf surface by placing a weight on one or more of the straps 240. It should be appreciated that in other embodiments, the anchor straps 240 are omitted and the base portion 252 of the body 213 is of a sufficient profile to stably maintain the body 213 in an upright position when in the extended position.

The body 213 also includes one or more vertical securing members or fasteners 230 to which an end 260 or 262 of an obstacle 218 is releasably fastened, as shown in FIG. 5A. In one embodiment, the securing members 230 are strips of fabric that are attached to the inner wall 219 of the body 213 and are oriented in a vertical direction. In the example shown in FIG. 5A, where the body 213 includes a plurality of securing members 230, the securing members 230 are arranged in a two-dimensional array across the width of the inner wall 219. That is, the securing members 230 are oriented in the vertical (Y) direction and several of the securing members 230 are arranged in the lateral (Z) direction. Thus, when two bodies 213a and 213b are spaced apart a distance in the lateral (Z) direction, one or more connecting obstacles 218 can be placed in different vertical (Y) positions and horizontal (Z) positions. In one example, a plurality of securing members 230 are spaced an approximately equal distance apart in the (Z) direction. It should be appreciated that there can be any suitable number of securing members 230 and they may be of any suitable width and length, and may be placed and oriented in any suitable fashion on the inner wall 219 of the body 213. Therefore, by orienting the securing members 230 in the vertical (Y) direction, the obstacles 218 may be easily attached at any desired height along the securing member 230. Moreover, by having a plurality of laterally spaced (Z) securing members 230, one or more obstacles 218 can be attached thereto, thereby giving the obstacle 218 a length (i.e., in the Z direction) for a participant or user to clear.

In an embodiment, the securing member 230 is a flexible elongated strap, belt, or piece of fabric that is sewn or otherwise secured to the body 213 in a non-removable fashion. The securing member 230 runs substantially along the entire height of the body 213 and is adapted to receive one end of the obstacle 218 (described below) at a plurality of different heights. In one embodiment, the securing member 230 includes a re-adjustable fastener such as of the hook-and-loop type (or burr and touch) located along the length of the securing member 230. In general, a hook type fastener is a piece of fabric covered with tiny plastic hooks, and a loop type fastener is a piece of fabric that is covered with even smaller plastic loops. It should be appreciated that variations to this configuration may be used which include hooks on both pieces of fabric, for example. When the hooks (or loops) on the securing member 230 contact the loops (or hooks) on the end 260, 262 of the obstacle 218, the hooks catch in the loops and removably attach the pieces together. As the end 260, 262 of the obstacle 218 includes a corresponding loop-type or hook-type fastener, and the securing member 230 is a vertical strip including the corresponding hook or loop fasteners, the obstacle 218 can be removably attached to the securing member 230 at any of a plurality of different heights. Therefore, the obstacle assembly 200 is able to function as an obstacle that can be adjusted to many different heights. As mentioned above, the plurality of horizontally spaced securing members 230 can accommodate a plurality of obstacles 218 across a lateral (Z) distance. Therefore, the obstacle assembly 200 can include a set of obstacles 218 that can be adjusted in both the height and length dimensions. In the example shown in FIG. 5A, the middle obstacle 218 is set higher than the outer two obstacles 218. This creates a ridge-shaped obstacle 218. It should be appreciated that any suitable number of obstacles 218 may be attached to the securing members 230 in any suitable placement and manner.

Although the securing member 230 is described above as a strip having a hook-type or loop-type fastening member, it should be appreciated that the securing member may be any suitable configuration that allows one or more obstacles 218 to be removably attached to the body 213 at a plurality of different heights. For example, the securing member 230 may include a plurality of snaps that mate with a snap included on the end 260, 262 of the obstacle.

Referring to FIG. 5A, in one embodiment, the securing member 230 is a strap or strip sewn onto the body 213, where the strip includes a first side having a fastener and a second side having a plurality of symbols, indicators, or markings 232. The markings 232 may be numbers that indicate the height from the ground. For example, the securing member 230 can include numbers indicating the number of inches from the ground at a plurality of different heights. In this example, when the jump obstacle 218 is removably attached to the securing member 230 of the body 213, the user will be able to determine the height of the obstacle 218. In another example, where the obstacle assembly 200 includes two obstacle supporters 212 spaced apart a distance, the markings 232 on one of the obstacle supporters 212 can be oriented in a first direction, and the markings 232 on a second one of the obstacle supporters 212 can be oriented in a second direction approximately 180° relative to the markings 232 on the first one of the obstacle supporters 212 (not shown). In this manner, the markings 232 are viewable when approaching the obstacle assembly 200 from either direction. In this example, it follows that the hook-type or loop-type fastener on the securing member 230 of the first body 213 would likewise be oriented approximately 180° from the hook-type or loop-type fastener on the securing member of the second body 213.

### B. Outer Supports and Spacers

Referring to FIG. 5A, the support for the body 213 includes a plurality of generally rectangular-shaped outer supports 214 and a plurality of rod-like or tubular spacers 215 between the outer supports 214. The outer supports 214 may be made of any suitable elastic material, such as plastic or metal, and form a flexible band, hoop or frame. That is, the outer supports 214 are rectangular shaped bands defining a large opening in the middle. In addition, outer supports 214 are not limited to a rectangular shape and may be square, oval, circular or any other suitable shape that at least partially conforms to the shape of the outer wall 219 and inner wall 217 of the body 213.

In an embodiment as shown in FIG. 5A, the front wall 221 of the body 213 includes one or more receivers or sleeves 270 that are configured to receive the spacers 215. The spacers 215 help maintain a designated distance between the outer supports 214 in the lateral (X) direction to provide a box-like structure. The spacer 215 is a substantially rigid member such a dowel or pole. The spacer 215 inserted into the sleeve 270 provides the front wall 221 of the body with rigidity. When the spacer 215 is inserted into the sleeve 270, the front wall 221 of the body 213 expands to a width in the lateral (X) direction corresponding to the length of the spacer 215, thus giving the body 213 the three-dimensional box-like shape. In one example, a plurality of sleeves 270 and spacers 215 are arranged about the perimeter of the front wall 221 of the body 213 for added rigidity. Therefore, the rectangular band-shaped outer supports 214, and the dowel shaped spacers 215 enable the body 213 to interchangeably expand and collapse in all three directions (XYZ).

One of the outer supports 214 is affixed, adhered or otherwise coupled to the outer wall 219 of the body 213. Similarly, a different one of the outer supports 214 is affixed, adhered or otherwise coupled to the inner wall 217 of the body 213. Where the body 213 is a fabric such as nylon, the rectangular-shaped outer supports 214 can be sewn into or onto the inner wall 217 and outer wall 219 of the body 213. In one example, the body 213 is a single sheet of fabric and the rectangular-shaped outer supports 214 are sewn onto a surface of the inner wall 217 and outer wall 219 of the body 213 with a strip of fabric that runs about the perimeter of the inner wall 217 and outer wall 219. In another example, the rectangular-shaped outer supports 214 are sewn between two separate sheets of fabric that form the inner wall 217 and outer wall 219 of the body 213. It should be appreciated that the outer supports 214 may be affixed or sewn to the inside, outside or otherwise coupled to the body 213 so as to at least partially support the body 213 in a vertical position.

In an embodiment, the outer supporting member or outer supports 214 are biased or predisposed to have a rectangular shape. In the predisposed rectangular shape, each of the outer supports 214 assumes a generally planar, rectangular shape with an opening in the middle. In this embodiment, expanding the obstacle supporters 212 to a working or use-state includes the following steps: (a) removing the securing member (not shown) to allow the inner wall 217 and outer wall 219 to unwrap and assume the generally rectangular shape of the outer supports 214; (b) inserting the spacers 215 into the receivers 270 to expand the bodies 213 in the lateral (X) direction; and (c) standing the obstacle supporters 212 to a vertical (Y) position to be able to receive one or more obstacles 218. Compressing or contracting the obstacle supporters 212 to a non-use or compacted state includes the following steps: (a) removing the spacers 215 from the receivers to contract or collapse the bodies 213 in the lateral (X) direction (as shown in FIG. 5C); (b) grasping both of the inner wall 217 and outer wall 219 at opposite ends with both walls positioned together; (c) twisting the inner wall 217 and outer wall 219 in a generally figure eight shape such that the body supports 214 twist into a series of smaller loops, as shown in FIG. 5D; (d) further compressing the twisted inner wall 217 and outer wall 219 to form a smaller or reduced profile; and (e) attaching the securing member or elastic strap (not shown) to hold the obstacle support 212 in the fully compacted state.

When both of the outer supports 214 are in the expanded or extended position, as shown in FIG. 5C, the body 213 has a certain rigidity with respect to the inner wall 217 and the outer wall 219. However, because in this embodiment, the front wall 221 is made out of a fabric, the front wall 221 lacks sufficient rigidity to enable the body 213 to assume a fully expanded three-dimensional shape. That is, the body 213 shown in FIG. 5C is only in a partially expanded state.

When the body 213 is in the fully contracted or compact position (see, FIG. 5D), the outer supports 214 store potential energy. In operation, when the securing member such as the elastic band (not shown) is released or removed, the outer supports 214 expand and release the stored potential energy as the body 213 converts from the compact state to the partially expanded or extended state. Then the spacers 215 are inserted into the sleeves 270 of the front wall 221 to further expand the body 213. As shown in FIG. 5A, the rectangular-shaped outer supports 214 include anchors 240 with the same structure and functions as described above.

### C. Obstacles

The obstacles 218 of the obstacle assembly 200 are provided between two or more obstacle supporters 212 and are positioned at a height above a ground level. As shown in FIG. 5A, one end 260 of the obstacle 218 is releasably attached to one of the securing members 230 of one of the obstacle supporters 212. Another end 262 of one of the obstacles 218 is releasably attached to another one of the obstacle supporters 212. As described above, the obstacles 218 can be attached to the obstacle supporters 212 at a plurality of different heights in the (Y) direction. Also, as shown in FIG. 5A, two or more obstacles 218 can be attached to the bodies 213 at different vertical (Y) and horizontal (Z) positions.

In one embodiment, the obstacle 218 is a flexible strap, as shown in FIG. 5A. The flexible strap includes an interior space that houses a filler such as a foam, a padding, or other suitable material. In one example, fabric is sewn around the padding to create a semi-rigid yet soft material, as described above. The fastener of the obstacle 218 is adapted to be releasably attached to the body 213 of the obstacle assembly 200. In an embodiment, the fasteners at the ends 260 and 262 of the obstacle 218 are located on opposing surfaces, as described above. In another embodiment, the obstacle 218 is a flexible strap adapted to receive a stiffening member, as described above.

### IV. Triangular Embodiment

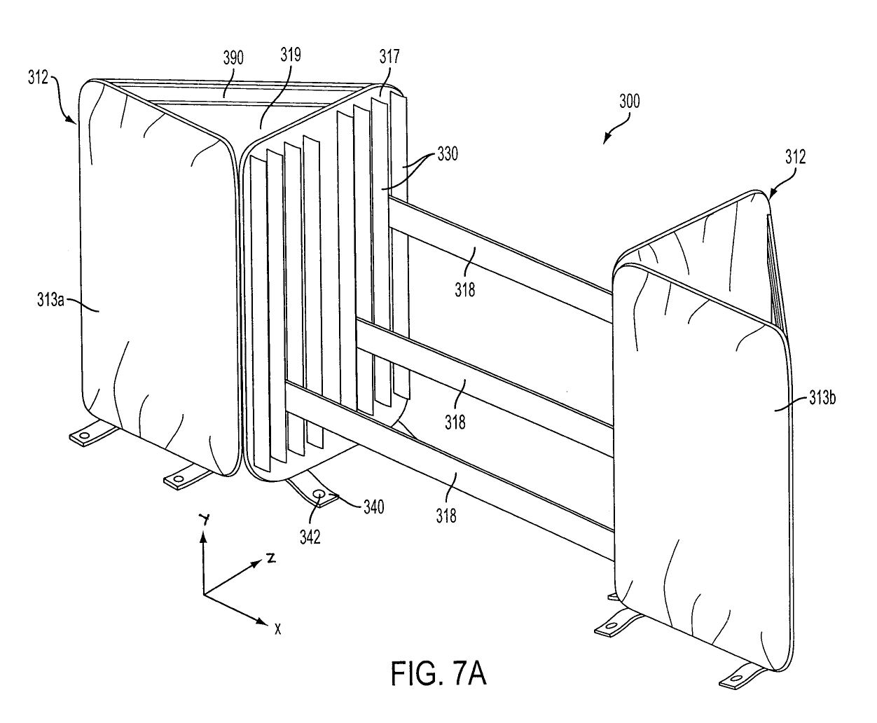

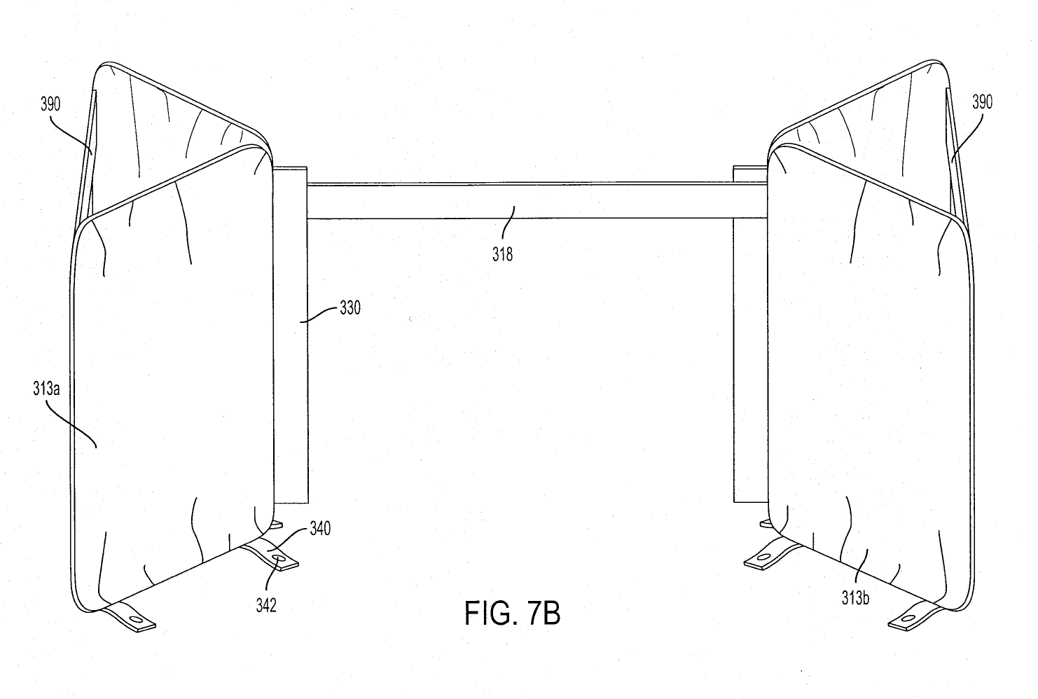

As illustrated in FIGS. 7A and 7B, in one embodiment the obstacle assembly 300 includes a plurality of obstacle supports 312 each having: (a) a plurality of triangular-shaped bodies 313a and 313b; and (b) a plurality of outer supports 314 and 315 operatively coupled to each of the bodies 313a and 313b, where each body support 314 generally corresponds to the triangular shape of the bodies 313a and 313b; and (c) one or more obstacles 318 removably attached to the bodies 313a and 313b.

### A. Triangular-Shaped Bodies

As shown in FIGS. 7A and 7B, the obstacle support 312 is operable between a compressed, collapsed, compacted, or non-use state and an expanded, extended or use-state state (as shown in FIG. 7A). The obstacle supporter 312 includes an inner wall 317 and an outer wall 319. The inner wall 317 is pivotally attached to the outer wall 319 through a common edge or seam 390. The common edge or seam 390 may further include a pivoting member or stiffener (not shown) such as a rod, a dowel, or a wire to add support or facilitate pivoting about the seam 390. The obstacle supporter 312 also includes a spacer 315.

The body 313 includes one or more fasteners or securing members (not shown) to retain the body 313 in a compressed or collapsed state, as described above. Referring to FIG. 7A, in an embodiment, the body 313 includes one or more tie down straps or anchor straps 340, as also described above.

The body 313 also includes one or more vertical securing members or fasteners 330 to which an end 360 or 362 of an obstacle 318 is releasably fastened, as shown in FIG. 7A. In one embodiment, the securing members 330 are strips of fabric that are attached to the inner wall 319 of the body 313 and are oriented in a vertical direction. In the example shown in FIG. 7A, where the body 313 includes a plurality of securing members 330, the securing members 330 are arranged in a two-dimensional array across the width of the inner wall 319. That is, the securing members 330 are oriented in the vertical (Y) direction and several of the securing members 330 are arranged in the lateral (Z) direction. Thus, when two bodies 313a and 313b are spaced apart a distance in the lateral (Z) direction, one more connecting obstacles 318 can be placed in different vertical (Y) positions and different horizontal (Z) positions. In one example, a plurality of securing members 330 are spaced an approximately equal distance apart in the (Z) direction. It should be appreciated that there can be any suitable number of securing members 330 and they may be of any suitable width and length, and may be placed and oriented in any suitable fashion on the inner wall 319 of the body 313. Therefore, by orienting the securing members 330 in the vertical (Y) direction, the obstacles 318 may be easily attached at any desired height along the securing member 330. Moreover, by having a plurality of laterally spaced (Z) securing members 330, one or more obstacles 318 can be attached thereto, thereby giving the obstacle 318 a length (i.e., in the Z direction) for a participant or user to clear.

In an embodiment, the securing member 330 is a flexible elongated strap, belt, or piece of fabric that is sewn or otherwise secured to the body 313 in a non-removable fashion, as described above.

Therefore, the obstacle assembly 300 is able to function as an obstacle that can be adjusted to many different heights. As mentioned above, the plurality of laterally spaced securing members 330 can accommodate a plurality of obstacles 318 across a lateral (Z) distance. Therefore, the obstacle assembly 300 can include a set of obstacles 318 that can be adjusted in both the height and length dimensions. In the example shown in FIG. 7A, the middle obstacle 318 is set higher than the outer two obstacles 318. This creates a ridge-shaped obstacle 318. It should be appreciated that any suitable number of obstacles 318 may be attached to the securing members 330 in any suitable placement and manner.

Although the securing member 330 is described above as a strip having a hook-type or loop-type fastening member, it should be appreciated that the securing member may be any suitable configuration that allows one or more obstacles 318 to be removably attached to the body 313 at a plurality of different heights. For example, the securing member 330 may include a plurality of snaps that mate with a snap included on the end 360, 362 of the obstacle.

Referring to FIG. 5A, in one embodiment, the securing member 230 is a strap or strip sewn onto the body 213, where the strip includes a first side having a fastener and a second side having a plurality of symbols, indicators, or markings 232, as described above.

### B. Outer Supports and Spacers

Referring to FIG. 7A, the support for the body 313 includes a plurality of generally rectangular-shaped outer supports 314 and a plurality of rod-like or tubular spacers 315 between the outer supports 314. The outer supports 314 may be made of any suitable elastic material such as plastic or metal and form a flexible band, hoop or frame. That is, the outer supports 314 are bands defining a large opening in the middle. In addition, outer supports 314 are not limited to a rectangular shape as shown and may be square, oval, circular or any other suitable shape that at least partially conforms to the shape of the outer wall 319 and inner wall 317 of the body 313.

In an embodiment as shown in FIG. 5A, the front wall 321 of the body 313 includes one or more receivers or sleeves 370 that are configured to receive the spacers 315. The spacers 315 help maintain a designated distance between one of the ends of the outer supports 314 in the lateral (X) direction to provide a triangular-like structure.

In an embodiments shown in FIGS. 7A and 7B, an edge 392 of the outer wall 319 is configured to receive an end 393 of the spacer 315, and an edge 391 of the inner wall 317 is configure to receive the other end 395 of the spacer 315. The spacer 315 is a substantially rigid member such a dowel or pole. The spacer 315 is attached to the edges of the inner and outer walls 393 and 395 to provide the body 313 with added rigidity. When the spacer 315 is attached, the inner wall 317 and outer wall 319 of the obstacle supporter 312 pivot about the seam 390 and expand to form a generally triangular three-dimensional shape. Therefore, the outer supports 314, and the spacer 315 enable the obstacle supporter 312 to interchangeably expand and collapse in all three directions (XYZ).

One of the outer supports 314 is affixed, adhered or otherwise coupled to the outer wall 319 of the body 313. Similarly, a different one of the outer supports 314 is affixed, adhered or otherwise coupled to the inner wall 317 of the body 313, as described above with respect to FIGS. 5A to 5D. In an embodiment, the outer supporting member or outer supports 314 are biased or predisposed to have a rectangular shape. In the predisposed rectangular shape, each of the outer supports 314 assume a generally planar, rectangular shape with an opening in the middle. In this embodiment, expanding the obstacle supporters 312 to a working or use-state includes the following steps: (a) removing the securing member (not shown) to allow the inner wall 317 and outer wall 319 to unwrap and assume the generally rectangular shape of the outer supports 314; (b) inserting the spacers 315 into the receivers 370 to expand the bodies 313 in the lateral (X) direction by pivoting one of the bodies 313a about the seam 390 and away from the second body 313b; and (c) standing the obstacle supporter 312 to a vertical (Y) position to be able to receive one or more obstacles 318. Compressing or contracting the obstacle supporters 312 to a non-use or compacted state includes the following steps: (a) removing the spacers 315 from the receivers 370 to contract or collapse the bodies 313 in the lateral (X) direction by pivoting one of the bodies 313a about the seam 390 and toward the second body 313b; (b) grasping both of the inner wall 317 and outer wall 319 at opposite ends with both walls positioned together; (c) twisting the inner wall 317 and outer wall 319 in a generally figure eight shape such that the body supports 314 twist into a series of smaller loops; (d) further compressing the twisted inner wall 317 and outer wall 319 to form a smaller or reduced profile; and (e) attaching the securing member or elastic strap (not shown) to hold the obstacle support 312 in the compacted state.

When the body 313 is in the contracted or compact position, the outer supports 314 store potential energy. In operation, when the securing member such as the elastic band (not shown) is released or removed, the outer supports 314 expand and releases the stored potential energy as discussed above. As shown in FIG. 7A, the triangular-shaped outer supports 314 include anchors 340 with the same structure and functions as described above.

### C. Obstacles

The obstacles 318 of the obstacle assembly 300 are provided between two or more obstacle supporters 312 and are positioned at a height above a ground level. As shown in FIG. 7A, one end 360 of the obstacle 318 is releasably attached to one of the securing members 330 of one of the obstacle supporters 312. Another end 362 of one of the obstacles 318 is releasably attached to another one of the obstacle supporters 312. As described above, the obstacles 318 can be attached to the obstacle supporters 312 at a plurality of different heights in the (Y) direction. Also, as shown in FIG. 7A, two or more obstacles 318 can be attached to the bodies 313 at different vertical (Y) and horizontal (Z) positions.

In one embodiment, the obstacle 318 is a flexible strap, as shown in FIG. 7A. The flexible strap includes an interior space that houses a filler such as a foam, a padding, or other suitable material. In one example, fabric is sewn around the padding to create a semi-rigid yet soft material, as described above. The fastener of the obstacle 318 is adapted to be releasably attached to the body 313 of the obstacle assembly 300. In an embodiment, the fasteners at the ends 360 and 362 of the obstacle 318 are located on opposing surfaces, as described above. In another embodiment, the obstacle 318 is a flexible strap adapted to receive a stiffening member 380, as described above.

Referring to FIG. 7B, the obstacle supports 312 have the same general configuration as the supports in FIG. 7A. However, in this embodiment, the securing member 330 is a single member that is attached at or near the edge or seam 390. Therefore, in this embodiment, one or more obstacles 318 can be positioned in the vertical (Y) direction along the edge 390.

In the above described embodiments, obstacle assemblies are provided that are operable to convert between an compact and an expanded state. The obstacle assembly are relatively lightweight, portable, and can be converted from one state to another with relative ease. In one embodiment, the obstacle supporters and obstacles are at least partially resilient and help to reduce the severity of any injuries associated with a collision between a participant or user.

One embodiment includes a tunnel which participants enter and exit. Here, the tunnel has the same structure, components and functionality as any one of the obstacle supporters described above. For example, such tunnel can be an obstacle supporter 112 positioned with its cylindrical side resting on the ground or floor. As such, the obstacle supporter 112 forms a channel through which a participant can pass.

In one embodiment, the obstacle assembly includes any suitable combination of any of the embodiments described above or any suitable portions of such embodiments. For example, the obstacle in the form of the strap, panel or hoop may be used as an obstacle in any of the embodiments.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An obstacle assembly comprising:
a plurality of obstacle supporters, at least one of the obstacle supporters having:
(a) a body which is at least partially flexible, and
(b) a body support which is coupled to the body and adjustable between a plurality of different sizes; and
at least one obstacle having a plurality of ends, each one of the ends connectable to one of the obstacle supporters.

2. The obstacle assembly of claim 1, wherein the body support is selected from the group consisting of a ring, a band, a rod, a wire, a dowel, a coil, a spring, a stiffener, a telescoping device, and an assembly of linked foldable segments.

3. The obstacle assembly of claim 1, wherein each of the obstacle supporters include a securing member having a plurality of markings.

4. The obstacle assembly of claim 1, wherein the jumping obstacle includes a receiver adapted to receive a spacer.

5. An obstacle assembly comprising:
a plurality of obstacle supporters, at least one of the obstacle supporters having:
(a) a body which is at least partially flexible and defines a wall, and
(b) a flexible line with a stiffness received by the wall, the flexible line adjustable to support the body at a plurality of different heights; and
at least one obstacle having a plurality of ends, each one of the ends connectable to one of the obstacle supporters.

6. The obstacle assembly of claim 5, wherein each of the obstacle supporters include a plurality of markings.

7. The obstacle assembly of claim 5, wherein each of the obstacle supporters include a plurality of securing members, at least one of the securing members having a plurality of markings.

8. The obstacle assembly of claim 5, wherein at least one obstacle connects a first one of the obstacle supporters to a second one of the obstacle supporters.

9. The obstacle assembly of claim 5, wherein the body is a shape selected from the group consisting of tubular, square, rectangular, triangular, and cylindrical.

10. The obstacle assembly of claim 5, wherein the body is comprised of a fully flexible material.

11. The obstacle assembly of claim 5, wherein the obstacle is selected from the group consisting of a hoop, a bar, a strap, and a curtain.

12. The obstacle assembly of claim 5, wherein the obstacle is a strap having a receiver, the receiver configured to receive a stiffener.

13. An obstacle supporter for an obstacle assembly, the obstacle supporter comprising:
a body which is at least partially flexible; and
a body support which is coupled to the body and adjustable between a plurality of different sizes.

14. The obstacle supporter of claim 13, wherein the body support is selected from the group consisting of a ring, a band, a rod, a wire, a dowel, a coil, a spring, a stiffener, a telescoping device, and an assembly of linked foldable segments.

15. The obstacle supporter of claim 13, wherein each of the obstacle supporters include a securing member having a plurality of markings.

16. The obstacle supporter of claim 13, wherein the body includes a receiver adapted to receive a spacer.

17. The obstacle supporter of claim 16, wherein the spacer is adapted to increase the size of the obstacle supporter.

18. The obstacle supporter of claim 13, wherein the body is a fully flexible material.

19. The obstacle supported of claims 13, wherein the body supporter is predisposed to be in a larger size.

20. The obstacle supporter of claim 19, wherein the body includes at least one retainer to at least partially retain the body and body supporter in a smaller size.
